(19) United States
(12) Patent Application Publication
(10) Pub. No.: US 2012/0187599 A1
(43) Pub. Date: Jul. 26, 2012

(54) DIRECT MOLDING MACHINE

(75) Inventor: Kensuke SUENAMI, Toyota-shi (JP)

(73) Assignee: KOJIMA PRESS INDUSTRY CO., LTD., Toyota-shi (JP)

(21) Appl. No.: 13/352,697

(22) Filed: Jan. 18, 2012

(30) Foreign Application Priority Data
Jan. 25, 2011 (JP) 2011012780

(51) Int. Cl. B29C 45/14; B29C 45/03

(52) U.S. Cl. 264/279; 425/129.1

(57) ABSTRACT

A direct molding machine may include a mold engageable with a previously formed substrate, and an injection unit. The mold is arranged and constructed to form a cavity defined by the mold and the substrate when the mold is engaged with the substrate. The injection unit is positioned below the substrate and is arranged and constructed to inject a resinous material into the cavity, so as to form a resin part on the substrate and to connect the same thereto.

### CROSS-REFERENCES TO RELATED APPLICATIONS

This application claims priority to Japanese Patent Application Serial Number 2011-012780 filed Jan. 25, 2011, the contents of which are incorporated herein by reference.

### BACKGROUND OF THE INVENTION

1. Field of the Invention

The present invention relates to a direct molding machine. More particularly, the present invention relates to a direct molding machine that is capable of injection-molding a resin article on a previously formed plate-shaped substrate and capable of connecting the resin article to the substrate.

2. Description of Related Art

A direct molding method in the present invention means a molding method which includes the steps of engaging a secondary mold with a substrate (which may be referred to as a primary molded article) previously formed using a primary mold to form a molding cavity between an outer surface of the substrate and an inner surface of the secondary mold, and injecting a resinous material into the molding cavity to form a resin article (e.g., a rivet, a clip, a rib or other such devices) on the substrate and to simultaneously connect the resin article to the substrate, thereby producing a final product that is composed of the substrate and the resin article. According to the direct molding method, the resin article (which may be referred to as a secondary molded article) having an intended shape can be formed on a desired portion of the substrate without changing the primary mold for forming the substrate. In addition, no connecting device is required to connect the resin article to the substrate. Therefore, it is possible to form a final article without increasing manufacturing costs. Further, the substrate may be composed of two laminated plate-shaped members in which a through bore is formed. In such a case, according to the direct molding method, the resin article can be formed as the rivet (i.e., a fastener) that is capable of connecting the laminated plate-shaped members. Thus, the laminated plate-shaped members can be connected to each other without using a fastener that is separately formed.

Further, polypropylene (PP) that can be melted at around 220 degrees C. may preferably be used as the resinous material of the resin article.

Conventionally, a vertical injection molding machine has been used as a direct molding machine for performing a direct molding operation. Such a vertical injection molding machine is taught, for example, by Japanese Laid-open Patent Publication Number 2008-284759.

Generally, it is advantageous if additional works can be simultaneously performed on the outer surface of the substrate when the resin article is formed on the outer surface of the substrate using the direct molding machine. Examples of the additional works are an attaching work of separately formed devices (screws, caps or other such devices) to the outer surface of the substrate, an applying work of adhesives to the outer surface of the substrate and other such works. However, in the known direct molding machine (the injection molding machine), an injection unit of the direct molding machine is positioned above the secondary mold, i.e., above the outer surface of the substrate, such that the resinous material can be easily and advantageously fed into the molding cavity. The injection unit thus positioned can be obstructive to the performance of the additional works on the outer surface of the substrate. Therefore, it is almost impossible to perform the additional works on the outer surface of the substrate while performing the direct molding operation. This means that the additional works must be performed after the direct molding operation is completed. This may lead to increased manufacturing costs of the final product.

Thus, there is a need in the art for an improved direct molding machine.

### SUMMARY OF THE INVENTION

In one embodiment of the present invention, a direct molding machine may include a mold engageable with a previously formed substrate, and an injection unit. The mold is arranged and constructed to form a cavity defined by the mold and the substrate when the mold is engaged with the substrate. The injection unit is positioned below the substrate and is arranged and constructed to inject a resinous material into the cavity, so as to form a resin part on the substrate and to connect the same thereto.

According to the present invention, the injection unit can be disposed below the substrate. That is, the injection unit is not positioned on or above the substrate, so that an upper surface of the substrate can substantially be opened. Therefore, additional works can be easily performed on the substrate while the resin part is formed on the substrate using the direct molding machine because the injection unit thus positioned cannot be obstructive to performance of the additional works on the substrate.

Further, the mold may have a first die and a second die that are capable of receiving the substrate there between by closing the mold. The cavity can be defined by the first die, the second die and the substrate.

Further, the mold may have a single die that is capable of receiving the substrate thereon. The cavity can be defined by the first die and the substrate.

Other objects, features and advantages of the present invention will be readily understood after reading the following detailed description together with the accompanying drawings and the claims.

### BRIEF DESCRIPTION OF THE DRAWINGS

FIG. 1 is an elevational view of a direct molding machine according to a representative embodiment of the present invention;

FIG. 2 is a side view of an injection unit of the direct molding machine;

FIG. 3 is a enlarged cross-sectional view taken along line III-III in FIG. 1, which view illustrates a condition in which a direct molding operation is not started;

FIG. 4 is a view similar to FIG. 3, which view illustrates a condition in which the direct molding operation is performed;

FIG. 5 is a view similar to FIG. 1, which view illustrates a modified form of the direct molding machine.

### DETAILED DESCRIPTION OF THE INVENTION

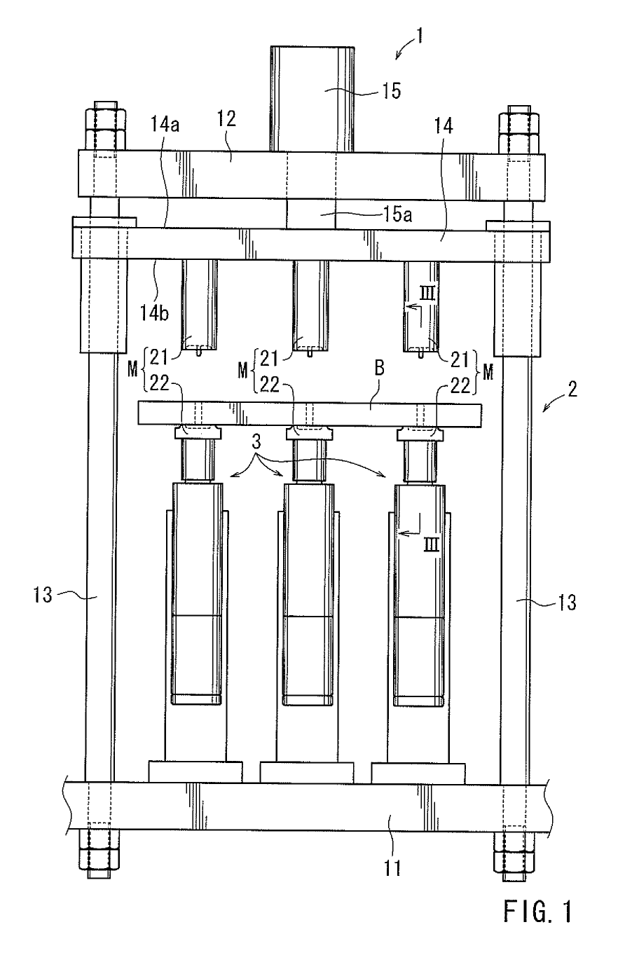

A detailed representative embodiment of the present invention will be described with reference to FIGS. 1 to 4.

As shown in FIG. 1, a direct molding machine 1 according to a representative embodiment of the present invention is intended to directly mold resin parts (secondary molded articles) on desired portions (molding portions) of an article or substrate B (a primary molded article) that is previously formed using a primary mold (not shown). The direct molding machine 1 is essentially constructed of a frame portion 2, a plurality of (three in this embodiment) molds M (secondary molds) that are used to form the resin parts (not shown) on the substrate B, and a plurality of (three in this embodiment) injection units (devices) 3.

The frame portion 2 is composed of a lower frame 11 (a stationary attachment member), an upper frame 12 positioned above the lower frame 11, a movable attachment member 14, and four guide shafts 13. The upper frame 12 is positioned in parallel with the lower frame 11 such that a lower surface of the upper frame 12 faces an upper surface of the lower frame 11. The guide shafts 13 are vertically positioned between the upper frame 12 and the lower frame 11 and are connected thereto at four corners thereof. The movable attachment member 14 is disposed below the upper frame 12 and is slidably connected to the guide shafts 13, so as to be movable vertically along the guide shafts 13.

Further, a hydraulic cylinder 15 (a mold clamping device or a die clamping device) is disposed on the upper frame 12. A cylinder rod 15a of the hydraulic cylinder 15 is projected downwardly passing through the upper frame 12 and is securely connected to an upper attachment surface 14a of the movable attachment member 14. Thus, upon actuation of the hydraulic cylinder 15, the movable attachment member 14 can move vertically along the guide shafts 13.

The molds M may preferably be arranged to be aligned with the molding portions of the substrate B. Each of the molds M is composed of a lower die 22 (a first die) and an upper die 21 (a second die). The upper die 21 of each of the molds M is attached to a lower attachment surface 14b of the movable attachment member 14. Further, the lower die 22 and the upper die 21 of each of the molds M respectively have engagement surfaces that are engageable with surfaces (upper and lower surfaces) of the substrate B. Each of the engagement surfaces of the lower die 22 and the upper die 21 may preferably have an area smaller than an area of each of the surfaces of the substrate B.

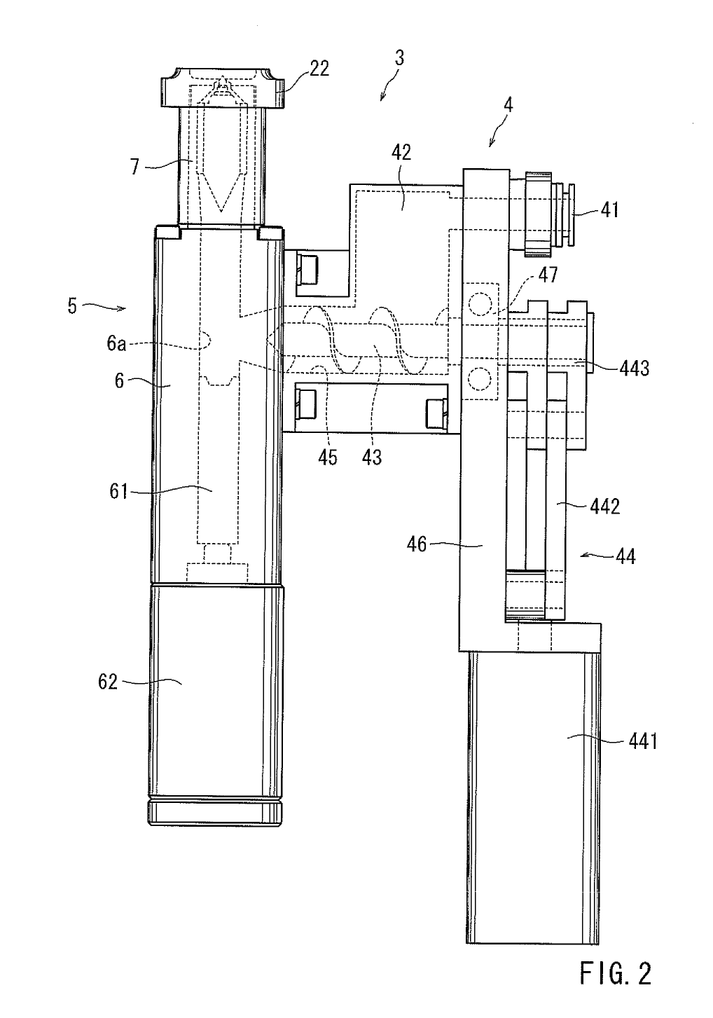

As shown in FIG. 1, the injection units 3 are respectively disposed on and secured to an upper surface (an attachment surface) of the lower frame 11. As shown in FIG. 2, each of the injection units 3 may preferably be composed of a material feeding portion 4 and an injecting portion 5. The material feeding portion 4 is capable of feeding a (palletized) resinous material toward the injecting portion 5. The injecting portion 5 is capable of melting the resinous material to form a molten resinous material therein and injecting the molten resinous material therefrom.

As shown in FIG. 2, the material feeding portion 4 may preferably include a cylindrical feeding passage 45 that is positioned horizontally, and a hopper 42 that is communicated with the feeding passage 45. The hopper 42 is constructed to contain the resinous material that is introduced thereinto via a resinous material input port 41. Further, the hopper 42 is arranged and constructed to feed the resinous material contained therein into the feeding passage 45.

As shown in FIG. 2, the material feeding portion 4 may include a screw 43 that is coaxially disposed in the feeding passage 45. The screw 43 may preferably be supported on a base plate 46 of the material feeding portion 4 via a bearing 47. Further, the material feeding portion 4 may include a drive mechanism 44. The drive mechanism 44 may have a drive cylinder 441 that is positioned below the base plate 46. The drive cylinder 441 may preferably be linked to the screw 43 via a link mechanism 442 and a one-way clutch unit 443, so as to rotate the screw 43 in one direction (in a predetermined direction).

As shown in FIG. 2, the injecting portion 5 may include a cylindrical main body 6 having an axial through bore 6a, an injection cylinder 62 connected to one (lower) end portion of the main body 6, and a nozzle 7 attached to the other (upper) end portion of the main body 6. The through bore 6a is communicated with the feeding passage 45 of the material feeding portion 4. The injection cylinder 62 may preferably be an air cylinder. The nozzle 7 may preferably be positioned axially aligned with the main body 6 and may preferably be internally communicated therewith. The injection cylinder 62 may preferably have a plunger 61 that is received within the through bore 6a of the main body 6. The plunger 61 is capable of moving or reciprocating therealong when the injection cylinder 62 is actuated.

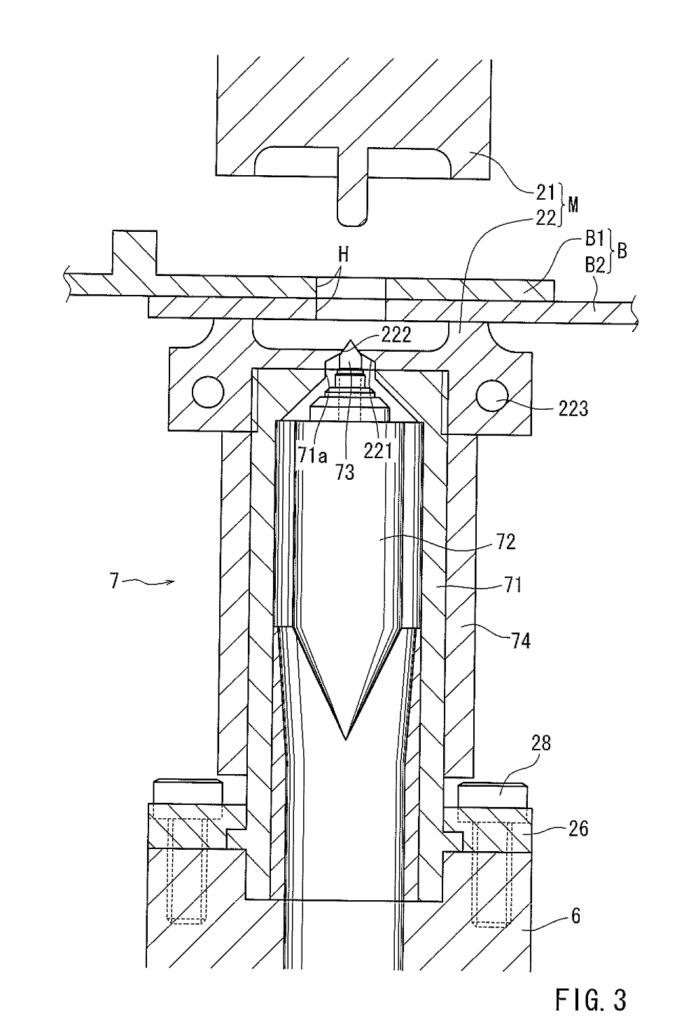

As shown in FIG. 3, the nozzle 7 may preferably be composed of a cylindrical nozzle body 71 having a through bore and a spindle-shaped torpedo 72 received in the through bore of the nozzle body 71. A proximal end portion of the nozzle body 71 is connected to the upper end portion of the main body 6 via a retainer 26 and a plurality of bolts 28. Conversely, a distal end portion of the nozzle body 71 has a reduced nozzle outlet 71a and is screwed on the lower die 22 of the corresponding mold M. Further, the nozzle 7 may preferably have a heater 74 that is circumferentially positioned around the nozzle body 71.

As shown in FIG. 3, the lower die 22 may preferably have a gate 222 (an injection port) that is formed in a central portion of a bottom wall thereof. The gate 222 may preferably be defined by a conical surface 221 that is tapered upwardly. The gate 222 may preferably be shaped to be aligned with the nozzle outlet 71a of the nozzle body 71. Also, the lower die 22 may preferably have a cooling device or cooling conduit 223 that is formed therein, so as to be effectively prevented from being excessively heated.

As shown in FIG. 3, the torpedo 72 has a needle valve 73 that is vertically movably (retractably) attached to an upper end thereof. The needle valve 73 may preferably be positioned to be aligned with the gate 222 formed in the lower die 22. Further, the needle valve 73 is constantly biased upwardly (i.e., in an injection direction) by a spring (not shown) that is disposed within the torpedo 72, so as to normally close the gate 222 of the lower die 22. Further, the needle valve 73 is arranged and constructed to be retracted into the torpedo 24 against a spring force of the spring when a pressure (resin pressure) applied between the gate 222 and the needle valve 73 (i.e., an end surface of the torpedo 72) is increased, so as to open the gate 222.

An operation of each of the injection units 3 thus constructed will now be described with reference to FIGS. 2 and 3.

The resinous material may preferably be introduced into the hopper 42 of the material feeding portion 4 via the resinous material input port 41. The resinous material contained in the hopper 42 may then be fed into the feeding passage 45. Conversely, upon actuation of the drive cylinder 441 of the drive mechanism 44, the screw 43 disposed in the feeding passage 45 can be rotated via the link mechanism 442 and the one-way clutch unit 443. As a result, the resinous material contained in the feeding passage 45 can be extruded into the through bore 6a of the main body 6 by increments.

Subsequently, the resinous material fed into the through bore 6a of the main body 6 may be conveyed into the through bore of the nozzle body 71 of the nozzle 7 by reciprocating motion of the plunger 61 due to actuation of the injection cylinder 62 of the injecting portion 5. The resinous material introduced into the nozzle body 71 may be transferred upwardly along the torpedo 72 under pressure. At this time, the resinous material may be heated by the heat from the heater 23 that is attached to the nozzle body 71. The heated resinous material may be melted around the torpedo 72 to form the molten resinous material therein. At this time, the pressure (resin pressure) applied between the gate 222 and the needle valve 73 can be increased because the molten resinous material thus formed is pressurized. As a result, the needle valve 73 of the torpedo 72 can be refracted into the torpedo 72 against the spring force of the spring, so that the gate 222 formed in the lower die 22 can be opened. Thus, the molten resinous material can be injected outwardly through the gate 222. When the molten resinous material is injected, the pressure (resin pressure) applied between the gate 222 and the needle valve 73 can be reduced. As a result, the needle valve 73 of the torpedo 72 can be projected from the torpedo 72 by the spring force of the spring, so that the gate 222 can be closed again.

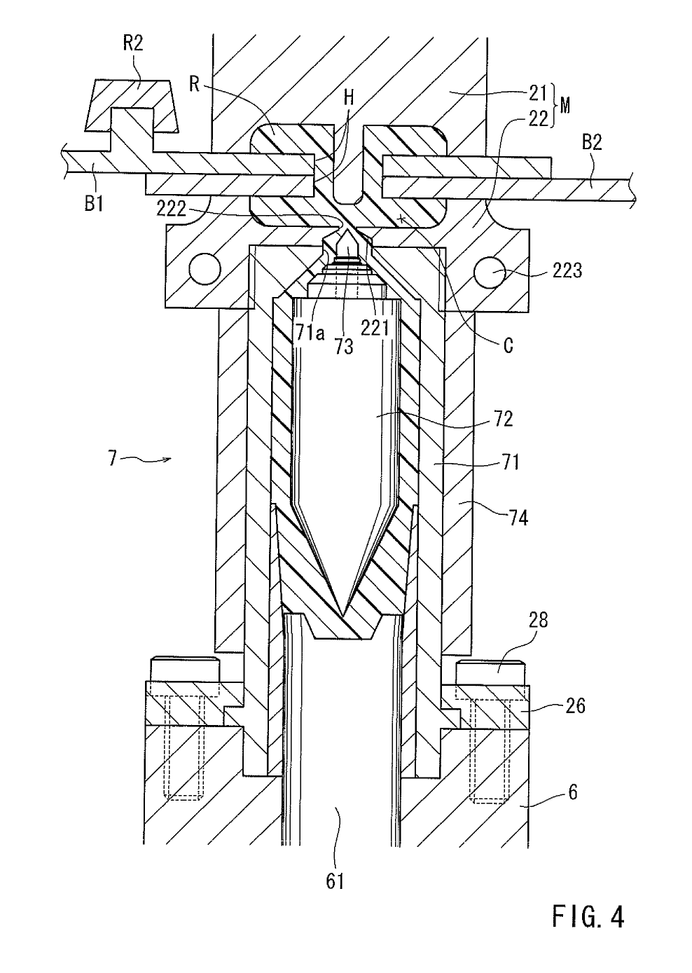

Next, a representative direct molding operation (process) using the direct molding machine 1 will be described with reference to FIGS. 3 and 4.

Further, in this embodiment, a floor cover is exemplified as the substrate B. The floor cover is composed of two laminated plate-shaped resin members B1 and B2 in which a plurality of through bores H (one of which is shown) are formed. Conversely, a plurality of connecting members or rivets R (one of which is shown) are exemplified as the resin parts.

First, as shown in FIG. 3, the laminated resin members B1 and B2 (the substrate B) are disposed on the lower dies 22 such that a lower surface of the laminated resin members B1 and B2 (the lower surface of the substrate B) contact the engagement surfaces of the lower dies 22 while the molds M (one of which is shown) are opened. At this time, the laminated resin members B1 and B2 may preferably be positioned on the lower dies 22 such that the through bores H are aligned with the gates 222 formed in the lower dies 22. Thereafter, the hydraulic cylinder 15 (FIG. 1) is actuated, so that the attachment member 14 supporting the upper dies 21 can be lowered along the guide shafts 13 until the engagement surfaces of the upper dies 21 contact an upper surface of the laminated resin members B1 and B2 (the upper surface of the substrate B), i.e., until the molds M are closed with interleaving the laminated resin members B1 and B2. Thus, molding cavities C capable of forming the rivets R may be formed on the laminated resin members B1 and B2 (FIG. 4). The molding cavities C thus formed may substantially be defined by inner surfaces of the first and second dies 21 and 22 of the molds M, the upper and lower surfaces of the laminated resin members B1 and B2, and circumferential surfaces of the through bores H.

Next, as previously described, the drive cylinder 441 of each of the material feeding portions 4 (FIG. 2) is actuated to rotate the screw 43, so that the resinous material contained in the feeding passage 45 can be extruded into the through bore 6a of the main body 6 of each of the injecting portions 5 (FIG. 2). Subsequently, the injection cylinder 62 of each of the injecting portions 5 is actuated, so that the resinous material can be conveyed into the through bore of the nozzle body 71 of the nozzle 7 of each of the injecting portions 5 by the plunger 61 of the injection cylinder 62. The resinous material introduced into the nozzle body 71 is then transferred upwardly along the torpedo 72 under pressure. The resinous material can be melted by the heater 23 while being transferred along the torpedo 72, so as to form the molten resinous material therein. The molten resinous material thus formed can then be injected into each of the cavities C through the gate 222 of the lower die 22 and be cooled therein. Thus, the rivets R can be formed on the laminated resin members B1 and B2 and be secured thereto, so that a final molded article composed of the laminated resin members B1 and B2 and the rivets R can be produced.

Thereafter, the hydraulic cylinder 15 is actuated in the reverse direction, so that the attachment member 14 can be lifted along the guide shafts 13. As a result, the molds M can be opened, so that the final molded article can be removed therefrom. Thus, the direct molding process can be completed.

As described above, according to the direct molding machine 1 of the present embodiment, the injection units 3 are disposed below the substrate B (the resin members B1 and B2) while only the upper dies 21 are disposed on the substrate B. That is, the injection units 3 are not positioned on or above the substrate B, so that the upper surface of the substrate B can substantially be opened. Therefore, additional works can be simultaneously performed on the substrate B when the rivets R are formed on the substrate B using the direct molding machine 1 because the injection units 3 thus positioned cannot be obstructive to performance of the additional works on the substrate B. That is, as shown in FIG. 4, it is possible to attach separately formed accessory devices R2 (screws, caps or other such devices) to the upper surface of the substrate B or to apply adhesives (not shown) to the upper surface of the substrate B. Further, the additional works can be performed by not only workers but also by robots. Thus, manufacturing costs of the final molded article can be effectively reduced.

Further, according to the direct molding machine 1, the molding cavities C can be formed on the substrate B by simply closing the molds M (the upper and lower dies 21 and 22) while the substrate B is interleaved therebetween. Therefore, the direct molding operation can be easily and effectively performed.

Further, according to the direct molding machine 1, the injection units 3 and the lower dies 22 of the molds M are secured to the lower frame 11. Conversely, the upper dies 21 of the molds M are attached to the movable attachment member 14. That is, in the direct molding machine 1, only the upper dies 21 attached to the movable attachment member 14 can be moved vertically. Therefore, a low-power hydraulic cylinder can be used as the hydraulic cylinder 15 (the mold clamping device) to move the movable attachment member 14.

Further, the substrate B is disposed on the lower dies 22 of the molds M. Therefore, the substrate B cannot be moved vertically when the hydraulic cylinder 15 is actuated to move the movable attachment member 14. That is, a height of the substrate B cannot be changed. Thus, the workers can have increased convenience to perform the additional works on the substrate B.

Various changes and modifications may be made to the representative embodiment without departing from the scope of the present invention. For example, in this embodiment, the direct molding machine 1 is constructed such that the upper dies 21 can be lowered along the guide shafts 13 to close the molds M. However, the direct molding machine 1 can be constructed such that the injection units 3 and the lower die 22 can be lifted or upwardly moved to close the molds M.

Further, in this embodiment, the resin parts (the secondary molded article) may be formed as the rivets R that are capable of connecting the resin members B1 and B2 (the substrate B). However, the resin parts may be formed as ribs, projections or walls that are simply formed on the lower surface of the substrate B. In this case, the molding cavities C can be simply defined by the inner surfaces of the lower dies 22 of the molds M and the lower surface of the substrate B. Therefore, in this case, the upper dies 21 of the molds M can be replaced with support members that are capable of pressing the substrate B downwardly.

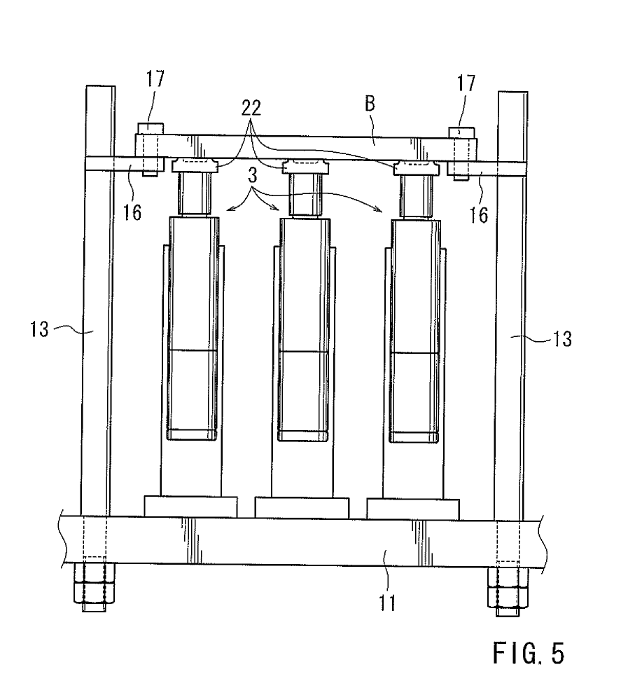

Further, as shown in FIG. 5, when the resin parts are simply formed on the lower surface of the substrate B, the hydraulic cylinder 15 (the mold clamping device) and the movable attachment member 14 can be omitted. However, in this case, retainer devices may preferably be attached to the guide shafts 13, so that the substrate B can be supported in place. Further, each of the retainer devices may preferably be composed of a bracket 16 and a screw 17. Further, the retainer devices can be omitted as necessary. That is, the substrate B can be supported by hand.

Further, according to the direct molding machine 1, the injection units 3 on which the lower dies 22 are disposed are directly secured to the lower frame 11 (the stationary attachment member). However, the injection units 3 can be connected to the lower frame 11 via a rotating plate (not shown) capable of horizontally rotating, so as to be moved to various horizontal positions on the lower frame 11. According to this structure, formation positions of the resin parts can be easily changed as necessary. In addition, according to this structure, the resin parts different in colors can be easily molded in series.

The direct molding machine 1 of the present invention is intended to directly mold the resin parts on the substrate B. However, the direct molding machine 1 can be used to separately form the resin parts. In addition, the number of the molds M and the injection units 3 can be changed as necessary. Further, in the embodiment, the floor cover that is composed of the resin members B1 and B2 is exemplified as the substrate B. However, various members made of metal or other such materials can be used as the substrate B.

A representative example of the present invention has been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detailed description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. A direct molding machine, comprising:
a mold engageable with a previously formed substrate; and
an injection unit,
wherein the mold is arranged and constructed to form a cavity defined by the mold and the substrate when the mold is engaged with the substrate, and
wherein the injection unit is positioned below the substrate and is arranged and constructed to inject a resinous material into the cavity, so as to form a resin part on the substrate and to connect the same thereto.

2. The direct molding machine as defined in claim 1, wherein the mold has a first die and a second die that are capable of receiving the substrate therebetween by closing the mold, and wherein the cavity can be defined by the first die, the second die and the substrate.

3. The direct molding machine as defined in claim 2 further comprising a die clamping device, wherein the die clamping device is arranged and constructed to move one of the first and second dies so as to close the mold.

4. The direct molding machine as defined in claim 1, wherein the mold has a single die that is capable of receiving the substrate thereon, and wherein the cavity can be defined by the first die and the substrate.

5. A method of directly molding a resin part on a previously formed substrate, comprising:
engaging a mold with the substrate to form cavity defined by the mold and the substrate,
positioning an injection unit below the substrate, and
injecting a resinous material into the cavity, so as to form the resin part on the substrate and to connect the same thereto,
wherein an engagement surface of the mold has an area that is smaller than an area of a surface of the substrate.
